(19) United States
(12) Patent Application Publication
(10) Pub. No.: US 2009/0168871 A1
(43) Pub. Date: Jul. 2, 2009

(54) Video motion estimation

(76) Inventors: Ning Lu, Folsom, CA (US); Samuel Wong, San Jose, CA (US); Hong Jiang, El Dorado Hills, CA (US); Brian Rauchfuss, Shingle Springs, CA (US)

Correspondence Address: TROP, PRUNER & HU, P.C., 1616 S. VOSS RD., SUITE 750, HOUSTON, TX, 77057-2631, US

(21) Appl. No.: 12/006,250

(22) Filed: Dec. 31, 2007

(51) Int. Cl. H04N 7/26

(52) U.S. Cl. 375/240.11

(57) ABSTRACT

In accordance with some embodiments of the present invention, distortion may be calculated using hardware for purposes of motion estimation. The distortion may be determined in the frequency domain. In some embodiments, a modified Haar wavelet transform may be utilized. The penalty in terms of the number of motion vectors may be determined for each location to achieve better distortion in some embodiments. A look up table may be utilized to determine an acceptable penalty. In some cases, the user can input information about an acceptable penalty.

### BACKGROUND

This relates to digital video image coding, and, in particular, to motion estimation for encoding video image data.

In order to transmit video images over narrow bandwidth channels and/or store video images efficiently, digital video data is preferably coded using known methods of compression. For example, to display real time motion video on personal computer systems having limited available memory and processing time, the digital image data is preferably encoded utilizing as much of the redundancy in sequences of image frames as possible. For example, successive images in a sequence are visually similar. One way to take advantage of this redundancy is to encode video images using motion estimation. In motion estimation, an image encoder generates motion vectors that indicate the relative movements of different regions from one image frame to form an approximation to various regions in the next image frame.

Video images that are encoded using motion estimation are decoded using motion compensation. In motion compensation, an image decoder approximates an image frame by moving different regions of the previous image frame according to the motion vectors generated by an encoder during motion estimation.

In conventional motion estimation, an image frame n is divided into rectangular or square sub-images called blocks. Each block of image frame n is then compared to the previous image frame n−1 to attempt to identify a region in the previous image frame n−1 that corresponds to that block of image frame n. A motion vector is then generated for each block of image frame n that has an identified corresponding region in image frame n−1. The motion vector indicates the relative vector distance between the block of image frame n and the corresponding region of image frame n−1.

### BRIEF DESCRIPTION OF THE DRAWINGS

FIG. 1 is a block diagram of an encoder according to one embodiment;

FIG. 2 is a hardware implementation of a distortion calculator in accordance with one embodiment;

FIG. 3 is a hardware implementation of a motion estimator with a maximum motion vector number limitation;

FIG. 4 is a sample piece-wise linear curve; and

FIG. 5 is a system depiction for one embodiment.

### DETAILED DESCRIPTION

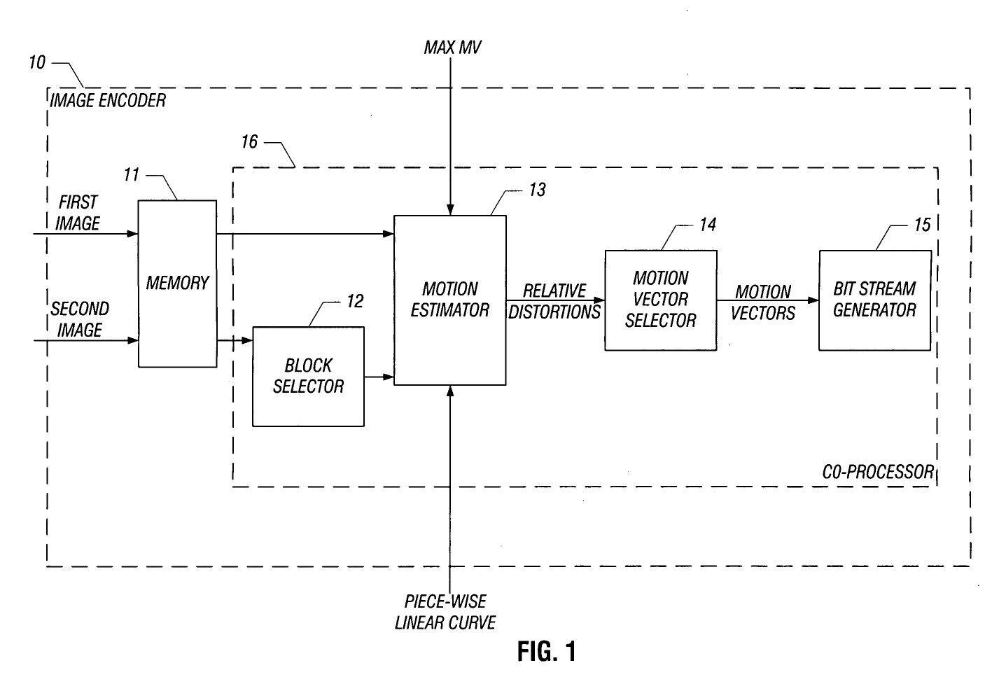

Referring to FIG. 1, there is shown a block diagram of image encoder 10, according to one embodiment. Image encoder 10 receives the first and second images and generates motion vectors used to encode the second image.

In particular, memory 11 of image encoder 10 receives the first and second images. Block selector 12 selects blocks of the second image, and motion estimator 13 compares the selected blocks to the first image to identify regions of the first image that correspond to the selected blocks of the second image. Motion vector selector 14 uses the relative distortions between corresponding blocks of the first and second images to select motion vectors with minimal weighted amount of distortions and bit-cost of describing these motion vectors that are used by bit stream generator 15 to encode the second image. In one embodiment, block selector 12, motion estimator 13, motion vector selector 14, and bit stream generator 15 are implemented in a co-processor 16.

Motion estimation involves the core full pixel motion searching process, also called integer motion search, a half pixel or quarter pixel refinement and bidirectional refinement, intra prediction as alternatives when no better motion prediction can be found, and a mechanism for selecting motion vectors.

The distortion of a motion vector is the discrepancy between the original pixels and their corresponding reference pixels in an area covered by the motion vectors using a predefined metric. The most commonly used metrics are the sum of absolute difference (SAD) and mean square error (MSE).

In video compression, pixel values are commonly stored in the frequency domain after standard discrete cosine transformation (DCT) or some variation of DCT transforms. Measuring distortion directly in the frequency domain may give a better compression result. However, it may be computationally expensive. By using an Haar based wavelet transform, a distortion metric may be calculated which is less computationally expensive. Further, through simplifications of the Haar based wavelet transform, computation may be further simplified and hardware may be used to do the distortion determination.

The Haar transform can apply to any number of entries in the power of two. In fact, starting from any sequence of 2N entries {x₀, x₁, . . . , x_{2N-1}}, a one 1-dimensional Haar transform step converts data sequences into two sequences of length N:

a low frequency sequence:

$$\{ \frac{\sqrt{2}}{2} ( {x}_{0} + {x}_{1} ) , \frac{\sqrt{2}}{2} ( {x}_{2} + {x}_{3} ) , … , \frac{\sqrt{2}}{2} ( {x}_{2 N - 2} + {x}_{2 N - 1} ) \} , and$$

a high frequency sequence:

$$\{ \frac{\sqrt{2}}{2} ( {x}_{0} - {x}_{1} ) , \frac{\sqrt{2}}{2} ( {x}_{2} - {x}_{3} ) , … , \frac{\sqrt{2}}{2} ( {x}_{2 N - 2} - {x}_{2 N - 1} ) \} .$$

The Haar wavelet transform, according to one embodiment, is obtained by repeatedly applying the 1-dimensional Haar transform step to the low frequency sequences until only one entry remains.

To apply the Haar wavelet to an image block, a 2-dimensional Haar transform may be modified by applying 1-dimensional steps horizontally and vertically alternately. Assuming a image block {p(x,y)}_{0≦x<2}_{ⁿ}_{,0≦y<2}_{^{m}}, a standard 2-dimensional Haar wavelet transform may be applied to the image block 2ⁿ×2^{m}.

In a first step, the horizontal Haar transform may be applied to every row to generate two blocks of 2ⁿ⁻¹×2^{m}:

{p^{L}(x,y)}_{0≦x<2}_{^{n−1}}_{,0≦y<2}_{^{m}}, and {p^{H}(x,y)}_{0≦x<2}_{^{n−1}}_{,0≦y<2}_{^{m}},

Where p^{L} is the lowest frequency components and p^{H} is the highest frequency components. Then a vertical Haar transform may be applied to every row of both 2ⁿ⁻¹×2^{m} blocks to have four 2ⁿ⁻¹×2^{m-1} blocks:

{p^{LL}(x,y)}_{0≦x<2}_{^{n−1}}_{,0≦y<2}_{^{m−1}}, {p^{HL}(x,y)}_{0≦x<2}_{^{n−1}}_{,0≦y<2}_{^{m−1}},

{p^{LH}(x,y)}_{0≦x<2}_{^{n−1}}_{,0≦y<2}_{^{m−1}}, and {p^{HH}(x,y)}_{0≦x<2}_{^{n−1}}_{,0≦y<2}_{^{m−1}},

Where p^{LL} are the lowest frequency components, p^{HH} are the highest frequency components, and p^{HL} and p^{LH} are intermediate frequency components. Finally, the above steps are repeatedly applied to {p^{LL}(x,y)}_{0≦x<2}_{^{n−1}}_{,0≦y<2}_{^{m−1}}.

Equivalently, the following pseudo codes may be used:

```
void Haar4×4TransformMethod1(int Block[4][4], int Haar[4][4])
{
  /First level 4-element horizontal Haar for 4 rows
  For(int j=0;j<4;j++) {
    temp[j][3] = (Block[j][2]−Block[j][3]);
    temp[j][2] = (Block[j][0]−Block[j][1]);
    temp[j][1] = (Block[j][2]+Block[j][3]);
    temp[j][0] = (Block[j][0]+Block[j][1]);
  }
  //First level 4-element vertical Haar for 2 columns
  For(int i=0;i<2;i++) {
    Haar[3][i] = (temp[2][i]−temp[3][i])/2;
    Haar[2][i] = (temp[0][i]−temp[1][i])/2;
    Haar[1][i] = (temp[2][i]+temp[3][i])/2;
    Haar[0][i] = (temp[0][i]+temp[1][i])/2;
  }
  //Second level 2-element horizontal Haar for 2 rows
    temp[1][1] = (Haar[1][0]−Haar[1][1]);
    temp[0][1] = (Haar[0][0]−Haar[0][1]);
    temp[1][0] = (Haar[1][0]+Haar[1][1]);
    temp[0][0] = (Haar[0][0]+Haar[0][1]);
  //Second level 2-element vertical Haar for 1 column
    Haar[1][1] = (temp[0][1]−temp[1][1])/2;
    Haar[0][1] = (temp[0][1]+temp[1][1])/2;
    Haar[1][0] = (temp[0][0]−temp[1][0])/2;
    Haar[0][0] = (temp[0][0]+temp[1][0])/2;
}
void Haar4×4TransformMethod2(int Block[4][4], int Haar[4][4])
{
  /First level 4-element horizontal Haar for 4 rows
  For(int j=0;j<4;j++) {
    Haar [j][3] = (Block[j][2]−Block[j][3])*HALFSQRT2;
    Haar [j][2] = (Block[j][0]−Block[j][1])*HALFSQRT2;
    Block[j][1] = (Block[j][2]+Block[j][3]);
    Block[j][0] = (Block[j][0]+Block[j][1]);
  }
  //First level 4-element vertical Haar for 2 columns
  For(int i=0;i<2;i++) {
    Haar [3][i] = (Block[2][i]−Block[3][i])/2;
    Haar [2][i] = (Block[0][i]−Block[1][i])/2;
    Block[1][i] = (Block[2][i]+Block[3][i])/2;
    Block[0][i] = (Block[0][i]+Block[1][i])/2;
  }
  //Second level 2-element horizontal Haar for 2 rows
  Haar [1][1] = (Block[1][0]−Block[1][1])*HALFSQRT2;
  Haar [0][1] = (Block[0][0]−Block[0][1])*HALFSQRT2;
  Block[1][0] = (Block[1][0]+Block[0][1]);
  Block[0][0] = (Block[0][0]+Block[0][1]);
  //Second level 2-element vertical Haar for 1 column
  Haar [1][0] = (Block[0][0]−Block[1][0])/2;
  Haar [0][0] = (Block[0][0]+Block[1][0])/2;
}
```

In some embodiments, this method has less computation, compared to the unmodified Haar wavelet, and the need for normalization of \sqrt{2} is avoided.

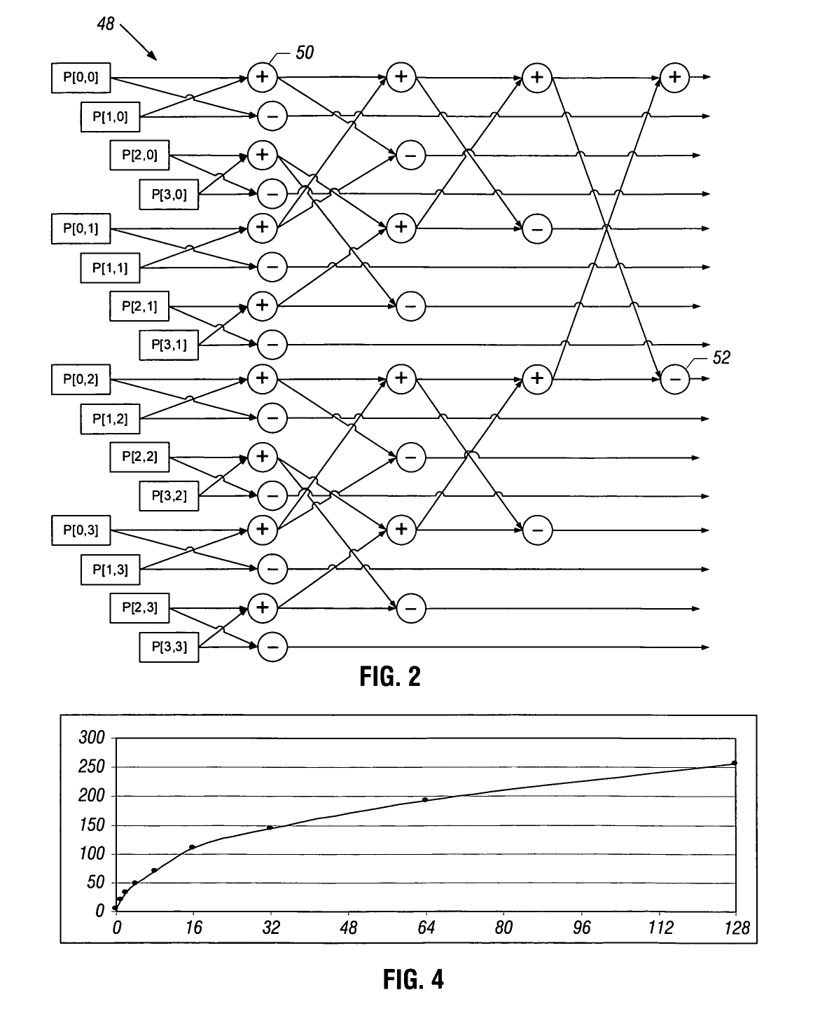

In accordance with one embodiment, the modified Haar transform may be implemented with the hardware 48, shown in FIG. 2, which may be part of the motion estimator 13 (FIG. 1) in accordance with one embodiment. An array of adders 50 and subtractors 52 may receive inputs from, in one embodiment, a 4×4 array of pixels p[0,0], p[1,0], p[2,0] . . . p[2,3], and p[3,3]. The calculation may be simplified relative to a conventional Haar transform in the elimination of the application of the factors of a square root of two over two and the limitation to the lower frequency components.

In video compression, prediction codes may be used instead of sending or storing the actual pixel data. For example, given two prediction codes for the same image portion, it would be desirable to use the prediction codes with less prediction distortion, if the cost of using the codes is either not an issue or is the same. The cost of using the codes is the number of bits that it takes to achieve that level of distortion. Generally, the better the distortion, the more bits that are needed to achieve it and the more overhead that may be involved in achieving the improved distortion. The overhead may result in the need for higher bandwidth transport or the inability to transport data at relatively high speeds.

Adjusted distortion is the sum of the distortion and the adjusted costing. The adjusted costing is the number of bits used to code the motion vector, multiplied by a factor called the quality parameter. The quality parameter λ may be determined by the particular compression scheme utilized. It indicates how much distortion will be tolerated. It can be chosen based on what distortion can be tolerated and what costs may be tolerated. The larger the λ, the larger the blocks that may be chosen for motion estimation, resulting in less cost. The smaller the λ, the smaller the blocks, but the higher the cost in terms of the number of bits. The number of bits that are required to code for a given distortion is called the code cost or the code penalty.

The adjusted distortion or code cost may be determined using hardware in one embodiment. In some embodiments of the present invention, the code cost is calculated, at each analyzed location, in hardware. This may be accomplished using a piece-wise linear curve (FIG. 4) to determine cost as indicated in FIG. 1. In one embodiment, eight locations on a frame may be chosen from among all the possible locations. Those eight locations are chosen because they give the least distortion and those are used to determine the piece-wise linear curve. While, in one embodiment, eight locations are utilized, the general idea is to use less than all the available locations and to choose a finite number of locations that have the best adjusted distortion.

In one embodiment, the piece-wise linear curve, as shown in FIG. 4, may be a logarithmic curve. The curve is graphed with a penalty measure on the vertical axis, while the horizontal axis gives the number of bits. The curve tells how much distortion can be tolerated to avoid extra cost.

In some embodiments, the piece-wise linear curve may be supplied by the user as indicated in FIG. 1. In other words, the user provides the system with the information it needs to make the tradeoff between higher distortion and lower cost. The system 10 can then effectively apply this curve to make the determination in each location of how much distortion can be tolerated.

Motion vectors may be stored relative to predicted motion vectors in horizontal and vertical components. The closer to the predicted motion vector, the less bits that are required to encode. The user can specify the prediction center and the costing penalty curve for adjusted distortion calculation. The prediction center is a pair of coordinates in a quarter pixel unit.

To simplify the penalty curve description, only eight key costing penalties at power of two locations in a quarter pixel unit are used. The eight locations are LUT_MV[8]:

0, 1, 2, 4, 8, 16, 32, and 64.

So the motion vector coordinate costing is defined to be:

Costing(v)=LUT_{—}MV[0], if v=0;

Costing(v)=LUT_{—}MV[p+1], if |v|=2^{p}, for any p≦6;.

Costing(v)=LUT_{—}MV[p+1]+((LUT_{—}MV[p+1]−LUT_{—}MV[p+2])*k)>>p,
if |v|=2^{p}+k, for any p<6 and k<2^{p}, and

Costing(v)=LUT_{—}MV[7]+|v|−64, if dx>64. [Ning: What are z and dx?]

And the total costing penalty for a motion vector mv is defined to be the sum of the horizontal and vertical components:

Costing(mv)=Costing (mv.x−pred.x)+Costing (mv.y−pred.y).

For further simplification, each costing penalty is stored in eight bits of two units of four bits each: base and shift. The costing value is specified as (base<<shift).

In addition to motion vector coding, the coding of macroblock partitioning types and modes may be covered by another set of mode lookup tables that specify the additional cost or penalties of using partitioning types and modes in one embodiment.

More than one set of lookup tables may simulate the potential quality variations needed to adjust macroblock level video qualities. To reduce the size of lookup tables, a fixed pattern with an updatable multiplier can be used and the size of lookup tables for motion vector components can also be limited to a small set of values near zero. The out-of-range motion vector costing can be assumed to follow a predefined linear pattern.

Thus, in some embodiments, distortion may be determined after transforming the data to the frequency domain and the distortion calculation may be done in hardware, using a modified Haar wavelet transform. The modified Haar wavelet transform may apply to the low frequency parts, while ignoring the higher frequency components to simplify the calculation and to make the calculation more suitable to a hardware implementation.

In one embodiment, the above techniques for determining distortion and adjusted distortion can be applied in systems where the maximum number of motion vectors may be limited. For example, some standards may be control the number of motion vectors. The issue then becomes how can one achieve the lowest possible distortion, given the constraint of a maximum number of motion vectors. For example, the Advanced Video Coding(AVC) (H.264) high profiles specify a maximum number of motion vectors. See MPEG-4 Part 10, ITU-T Video Coding Experts Group, International Telecommunications Union, Telecommunications Standardization Sector, Geneva, Switzerland.

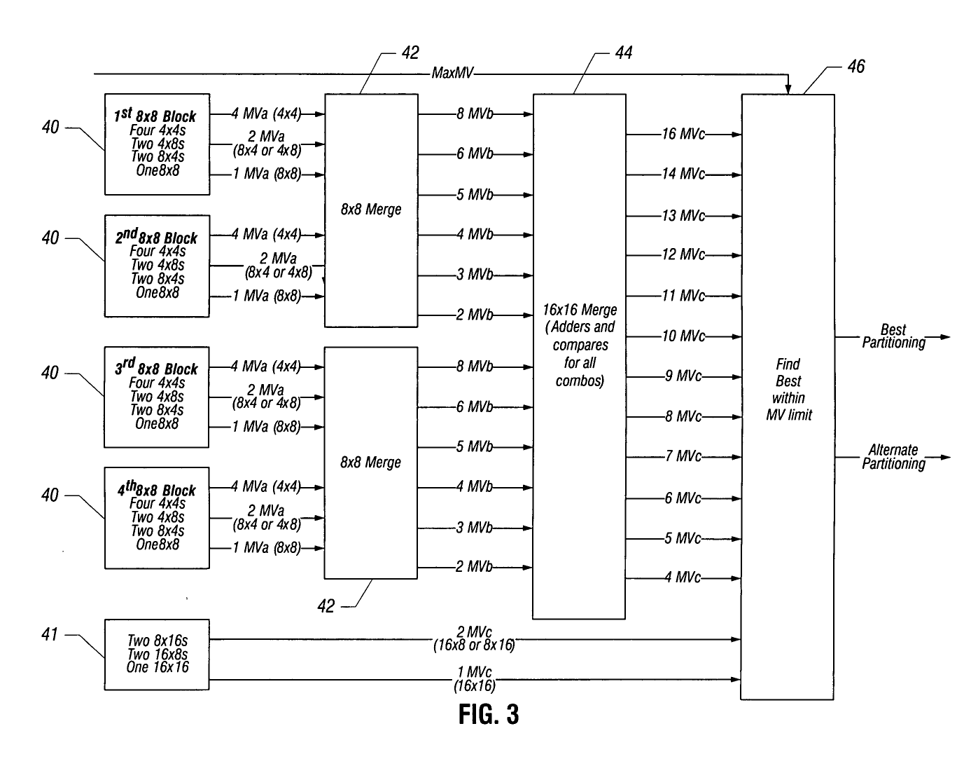

Referring to FIG. 3, a 16×16 source block can be undivided (i.e. one single motion vector for the entire block), divided into two 16×8 blocks, divided into two 8×16 blocks, (the above three cases are described in block 41), or further divided into four 8×8 sub-blocks or even smaller. For each of four individual 8×8 blocks 40, one of two motion vector choices may be eliminated. Either the two 8×4 or two 4×8's may be eliminated based on the minimal overall adjusted distortion determined, for example, as described above. Three choices are then output as one motion vector a, which is an 8×8 motion vector, two motion vectors a, which are 8×4's or 4×8's, and four motion vectors a, which are 4×4's.

Then, in block 42, the first 8×8 block's three choices and the second 8×8 block's three choices are combined into six pairs. One motion vector a and another motion vector a are chosen for two motion vectors b. One of one motion vector a and two motion vector a's are chosen and one of two motion vector a's and one motion vector a are chosen for three motion vector b's. Next, the two motion vector a's and two motion vector a's are chosen for four motion vector b's. Then a selection is made between (one motion vector a and four motion vector a's) and (four motion vector a's and one motion vector a) for five motion vector b's. Then, one of (two motion vector a's and four motion vector a's) or (four motion vector a's and two motion vector a's) are chosen for six motion vector b's. Finally, four motion vector a's and four motion vector a's are chosen for eight motion vector b's.

The third 8×8 block 40's three choices and the fourth 8×8 block 40's three choices are combined into six pairs similarly using another 8×8 merge 42.

In block 44, the two previous groups are compared as twelve candidates. One 16×16 block is chosen for one motion vector c. One of two 16×8 or two 8×16 blocks are chosen for two motion vector c's. Two motion vector b's from the top group and two motion vector b's from the bottom group are chosen for four motion vector c's. As a notation, we say 4MVc is derived by combining (2, 2)MVb. Similarly, for five motion vector case, we merge (2,3)Mvb (i.e. two motion vector b's from the top group and three motion vector b's from the bottom group) and (3,2)MVs (three motion vector b's from the top group and two motion vector b's from the bottom group) to generate five motion vector c's, 5MVc. One of the group of two motion vector b's and four motion vector b's (2,4)MVb or the group of four motion vector b's and two motion vector b's (4,2)MVb or the group of three motion vector b's and three motion vector b's (3,3)MVb are chosen for six motion vector c's, 6MVc. Analogously, one of the best among (2,5) motion vector b's, (5,2) motion vector b's, (3,4) motion vector b's and (4,3) motion vector b's are chosen for seven motion vector c's. One of (2,6) motion vector b's (6,2) motion vector b's, (3,5) motion vector b's, (5,3) motion vector b's, and (4,4) motion vector b's are chosen for eight motion vector c's. One of (3,6) motion vector b's, (6,3) motion vector b's, (4,5) motion vector b's, or (5,4) motion vector b's are chosen for nine motion vector c's. Then, one of (2,8) motion vector b's, (8,2) motion vector b's, (4,6) motion vector b's, (6,4) motion vector b's, or (5,5) motion vector b's are chosen for ten motion vector c's. Then, one of (3,8) motion vector b's, (8,3) motion vector b's, (5,6) motion vector b's, or (6,5) motion vector b's are chosen for eleven motion vectors. Thereafter, one of (4,8) motion vector b's, (8,4) motion vector b's, and (6,6) motion vector b's are chosen for twelve motion vectors. One of (5,8) motion vector b's and (8,5) motion vector b's are chosen for thirteen motion vector c's. One (6,8) motion vector b's and (8,6) motion vector b's are chosen for fourteen motion vector c's. Finally, an 8 motion vector b and 8 motion vector b are chosen for sixteen motion vector c's.

In the next step, the best motion vector c's are chosen at block 46 with the number of motion vector chosen being less than the specified maximum motion vector number.

In some embodiments, to ensure that the best choice is chosen, it may be desirable to select more than one result.

There may be many ways to pick multiple candidates. Among the ways include picking additional results from some predefined distortion tolerance. Then, all the results that are picked have an adjusted distortion that is not worse than the tolerance T from the best result.

As another alternative, more than one, but a fixed number of best results can be chosen. As still another possibility, the last 14 results can be split into k disjoint groups and k−1 additional results may be picked such that there is always one from each group. For example, the results may be split into three groups. One group contains only one motion vector c and two motion vector c's and the other contains all the other results.

In some cases, the above three techniques may be used together. For example, if method one and method two are combined, this results in extra results only for ones whose distortion is within the tolerance.

The process just described is normally performed after an integer pixel motion search, fractional motion search, and bidirectional search for all possible candidate sub-blocks. Commonly, 41 sub-blocks of the 6×16 macroblock where there is one 16×16, two 16×8's, two 8×16's, four 8×8's, eight 8×4's, eight 4×8's, and sixteen 4×4 blocks. However, the number of sub-blocks may vary according to the allowed sub-partitioning. For example, to be reduced to 25 is 8×4's and 4×8s are not allowed or it may be increased if more partitioning is allowed as in a field mode or in a smaller block size or in a regular shape.

However, for reduced computation and power saving, the macroblock partitioning may be performed earlier, either after fractional search or right after integer search. The later refinement steps can apply only to the sub-blocks that are involved in the best chosen partition.

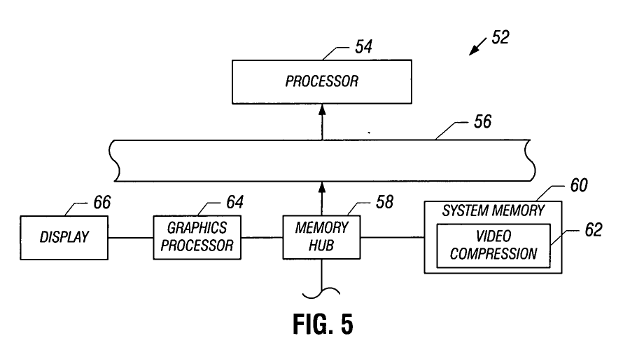

Referring to FIG. 5, in one embodiment, a computer system 52 may include the image encoder 10 shown in FIG. 1. The computer system 52, in one embodiment, may include at least one processor 54 coupled by a bus 56 to a memory hub 58. The memory hub may be coupled to system memory 60 that includes a video compression storage 62 in one embodiment. The memory hub 58 may also be coupled to a graphics processor 64 that may be coupled to a display 66 in one embodiment. The image encoder 10 may be part of the graphics processor 64, in one embodiment. Of course, other architectures may be used as well.

In some embodiments, the video compression storage 62 may store a look up table to determine an acceptability penalty for bit costing. However, in other embodiments, this table may be stored within the motion estimator 13 or the motion vector selector 14 shown in FIG. 1.

In some embodiments, the components or sequences illustrated in FIG. 3 may be implemented within the motion vector selector 14 in hardware in FIG. 1. In other embodiments, they may be implemented in software, for example, stored as part of the video compression storage 62 shown in FIG. 5.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
estimating motion in video frames by detecting distortion in the frequency domain using hardware.

2. The method of claim 1 including using an Haar wavelet to determine distortion.

3. The method of claim 2 including eliminating the square root divided by two multiplication when using the Haar wavelet.

4. A method comprising:
estimating motion in video frames by determining the penalty at each location due to the use of more motion vectors to achieve better distortion.

5. The method of claim 4 including using a look up table to determine an acceptable penalty for bit costing.

6. The method of claim 5 including enabling the user to input information about an acceptable penalty.

7. The method of claim 5 including using a logarithmic curve to specify the acceptable penalty at different locations.

8. The method of claim 5 including storing penalties as a look up table using eight bits per penalty.

9. The method of claim 8 including minimizing distortion for a predetermined number of motion vectors.

10. The method of claim 4 including using a predetermined number of motion vectors to determine which locations to use to estimate motion.

11. The method of claim 10 including selecting the best motion vector partitioning for a given total number of motion vectors.

12. The method of claim 10 including selecting a first 8×8 block of pixel data and selecting for that block motion vectors for four 4×4 blocks, two 8×4 blocks, and one 8×8 block.

13. The method of claim 12 including selecting motion vectors for four 4×4, two 8×4 or 4×8 blocks, and one 8×8 block from a second 8×8 block of pixel data and then selecting from among the motion vectors for the first and second blocks to generate a plurality of selected motion vectors.

14. The method of claim 13 including selecting motion vectors from third and fourth blocks of pixel data, merging the selected motion vectors from the third and fourth blocks and then merging motion vectors from said first, second, third, and fourth blocks.

15. The method of claim 14 including selecting the motion vectors that produce the least distortion for a given number of motion vectors.

16. An image encoder comprising:
a memory; and
a block selector coupled to said memory, said block selector to detect distortion in the frequency domain using hardware.

17. The encoder of claim 16 wherein said block selector to use a Haar wavelet to determine distortion.

18. The encoder of claim 17, said encoder to eliminate the square root divided by two multiplication when using the Haar wavelet.

19. An image encoder comprising:
a memory; and
a block selection coupled to said memory to determine the penalty at each image location due to the use of more motion vectors to achieve better distortion.

20. The encoder of claim 19, said memory to store a look up table to determine an acceptable penalty for bit costing.

21. The encoder of claim 20, said encoder to enable the user to input information about an acceptable penalty.

22. The encoder of claim 21, said encoder to use a logarithmic curve to specify the acceptable penalty at different locations.

23. The encoder of claim 22, said memory to store penalties as a look up table using eight bits per penalty.

24. The encoder of claim 23, said encoder to minimize distortion for a predetermined number of motion vectors.

25. The encoder of claim 19, said encoder to use a predetermined number of motion vectors to determine which locations to use to estimate motion.

26. The encoder of claim 25, said block selector to select the best motion vector partitioning for a given total number of motion vectors.

27. The encoder of claim 25 including a selector to select a first 8×8 block of pixel data and to select for that block motion vectors for four 4×4 blocks, two 8×4 blocks, and one 8×4 blocks.

28. The encoder of claim 27 including a second selector to select motion vectors for four 4×4, two 8×4 or 4×8 blocks, and one 8×8 block from a second 8×8 block of pixel data and then to select from among the motion vectors for the first and second blocks to generate a plurality of selected motion vectors.

29. The encoder of claim 28 including a third selector to select motion vectors from third and fourth blocks of pixel data, merge the selected motion vectors from the third and fourth blocks and then merge motion vectors from first, second, third, and fourth blocks.

30. The encoder of claim 29 wherein said third selector to select motion vectors that produce the least distortion for a given number of motion vectors.
